(19) United States
(12) Patent Application Publication
(10) Pub. No.: US 2008/0239187 A1
(43) Pub. Date: Oct. 2, 2008

(54) THIN FILM TRANSISTOR ARRAY PANEL AND METHOD OF MANUFACTURING THE SAME

(75) Inventors: Byung-Duk YANG, Suwon-si (KR); Hyang-Shik KONG, Seongnam-si (KR); Sang-Ki KWAK, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/933,044

(22) Filed: Oct. 31, 2007

(30) Foreign Application Priority Data
Mar. 30, 2007 (KR) 10-2007-0031513

(51) Int. Cl. G02F 1/1368; G02F 1/1333

(52) U.S. Cl. 349/44; 349/43; 438/30

(57) ABSTRACT

A thin film transistor array panel includes; a substrate, a light blocking member disposed on the substrate wherein the light blocking member forms a storage space, a gate line which extends in a first direction on the substrate and includes a gate electrode, a gate insulating layer disposed on the gate line, a semiconductor disposed on the gate insulating layer, a data line disposed on the gate insulating layer, which extends in a second direction, and includes a source electrode, a drain electrode disposed substantially opposite the source electrode on the semiconductor, a passivation layer disposed on the data line and the drain electrode and which includes a contact hole which exposes the drain electrode, a color filter disposed within the storage space, and a pixel electrode disposed on the passivation layer and connected to the drain electrode through the contact hole.

This application claims priority to Korean Patent Application No. 10-2007-0031513, filed on Mar. 30, 2007, and all the benefits accruing therefrom under 35 U.S.C. § 119, the contents of which in its entirety are herein incorporated by reference.

### BACKGROUND OF THE INVENTION

(a) Field of the Invention

The present invention relates to a thin film transistor (“TFT”) array panel and a method of manufacturing the same.

(b) Description of the Related Art

A liquid crystal display (“LCD”) is one type of commonly used flat panel display. It includes two display panels in which electrodes are formed and a liquid crystal layer inserted therebetween. LCDs are display devices which rearrange liquid crystal molecules of the liquid crystal layer by applying a voltage to the electrodes to thereby adjust the orientation of the liquid crystals and thereby adjust the amount of light transmitted therethrough.

The LCD further includes a color filter for displaying a color using a light transmitting liquid crystal layer, and the color filter is typically positioned at a display panel on which a common electrode is formed. The color filter typically includes red, green, and blue colors. When coupling the two display panels, the display panels are optimally arranged such that each pixel corresponds to a single color of the color filter on the opposing display panel. However, this configuration presents a problem in that any alignment errors between the two display panels reduces the area through which light passed by the pixels may be seen, and thus an aperture ratio of the display decreases. Essentially, the liquid crystal molecules of the individual pixels continue to function as intended, but the color filter which overlays them blocks some portion of the light transmitted therethrough.

In order to overcome the problem, technology of forming a color filter in a display panel using a photolithography process and forming a TFT thereon has been proposed. However, in such a proposed display there is a technical limitation such that a TFT must be manufactured at a low temperature due to the poor heat resistance of the color filter. Furthermore, in such a proposed display the color filter covers a drain electrode, and in order to manufacture a pixel electrode, a contact hole must be formed in an overcoat which covers the color filter and the contact hole must continue through the color filter itself to correspond to the contact hole of the overcoat. This presents additional difficulty to exposing the drain electrode.

### BRIEF SUMMARY OF THE INVENTION

The present invention provides exemplary embodiments of a thin film transistor array panel and exemplary embodiments of a method of manufacturing the same having advantages of simplifying a method of manufacturing a liquid crystal display and easily forming a color filter.

An exemplary embodiment of a thin film transistor array panel includes; a substrate; a light blocking member disposed on the substrate, wherein the light blocking member forms a storage space, a gate line which extends in a first direction on the substrate and includes a gate electrode, a gate insulating layer disposed on the gate line, a semiconductor disposed on the gate insulating layer, a data line disposed on the gate insulating layer, which extends in a second direction, which is disposed at an angle to the first direction, and includes a source electrode, wherein at least a part of the source electrode is positioned on the semiconductor, a drain electrode disposed substantially opposite the source electrode on the semiconductor, a passivation layer disposed on the data line and the drain electrode and which includes a contact hole which exposes the drain electrode, a color filter disposed within the storage space; and a pixel electrode disposed on the passivation layer and which is connected to the drain electrode through the contact hole.

In one exemplary embodiment the pixel electrode may be disposed on the color filter, the thin film transistor array panel may further include a storage electrode line disposed in the first direction on the light blocking member.

In one exemplary embodiment the gate line and the data line may be positioned on the light blocking member, and the thin film transistor array panel may further include an ohmic contact disposed between the semiconductor and the data line, and between the semiconductor and the drain electrode.

In one exemplary embodiment the ohmic contact may be disposed in substantially the same pattern as that of the data line and the drain electrode.

In one exemplary embodiment the thin film transistor array panel may further include a shielding electrode disposed on the passivation layer and extending in the second direction substantially along the data line, and may further include an overcoat disposed between the color filter and the pixel electrode.

In one exemplary embodiment the color filter may be formed on the passivation layer within the storage space.

In one exemplary embodiment the data line may include a first data line disposed at the left side of the storage space and a second data line disposed at the right side of the storage space, and the pixel electrode may include a first subpixel electrode which receives a data voltage from the first data line and a second subpixel electrode which receives a data voltage from the second data line.

In one exemplary embodiment the first data line, the second data line, the drain electrode, and the source electrode may be positioned on the light blocking member.

In another exemplary embodiment of the present invention a thin film transistor array panel includes; a substrate, a light blocking member disposed on the substrate, a gate line positioned on the light blocking member and which extends in a first direction, a data line positioned on the light blocking member and which extends in a second direction which is disposed at an angle to the first direction, a thin film transistor positioned on the light blocking member and which is connected to the gate line and the data line, and a pixel electrode connected to the thin film transistor.

In one exemplary embodiment the light blocking member forms a storage space and a color filter is disposed within the storage space.

In yet another exemplary embodiment of the present invention a method of manufacturing a thin film transistor array panel, includes; disposing a light blocking member, which forms a plurality of isolated storage spaces, on a substrate, disposing a gate line extending in a first direction on the substrate, disposing a gate insulating layer on the gate line, disposing a semiconductor on the gate insulator layer, disposing a data line extending in a second direction, which is disposed at an angle to the first direction, on the substrate, disposing a drain electrode extending in the second direction on the substrate, disposing a passivation layer on the data line and the drain electrode, disposing a color filter within the storage spaces, and disposing a pixel electrode in connection with the drain electrode.

In one exemplary embodiment the forming of the color filter may include; injecting ink within the storage spaces, and hardening the ink.

In one exemplary embodiment the gate line and the data line may be positioned on the light blocking member, and the forming of the gate line further includes positioning a storage electrode line extending in the first direction on the light blocking member.

In one exemplary embodiment the method may further include forming an ohmic contact layer after disposing the semiconductor and before disposing the data line.

In one exemplary embodiment the disposing a semiconductor, the disposing of an ohmic contact layer, and the disposing of a data line and a drain electrode may include; sequentially disposing a semiconductor layer, an ohmic contact layer, and a metal layer on the gate insulating layer, disposing a first photosensitive film pattern having a position-varying thickness on the metal layer, etching the metal layer, the ohmic contact layer, and the semiconductor layer using the first photosensitive film pattern as a mask, forming a second photosensitive film pattern which exposes at least a portion of the metal layer by ashing the first photosensitive film pattern, and etching the exposed metal layer and the ohmic contact layer using the second photosensitive film pattern as a mask.

### BRIEF DESCRIPTION OF THE DRAWINGS

The above and other features and advantages of the present invention will become apparent and more readily appreciated from the following description of the exemplary embodiments, taken in conjunction with the accompanying drawings, in which:

FIG. 1 is a cross-sectional view of an exemplary embodiment of a liquid crystal panel assembly according to the present invention;

FIG. 2 is a top plan view layout illustrating an exemplary embodiment of a thin film transistor (“TFT”) array panel according to the present invention;

FIG. 3 is a cross-sectional view taken along line III-III of FIG. 2;

FIG. 4A is a cross-sectional view taken along lines IV-IV and IV′-IV′ of FIG. 2;

FIG. 4B is an enlarged view of the region “B” in FIG. 4A;

FIGS. 5, 8, 11, 14, and 19 are top plan view layouts sequentially illustrating an exemplary embodiment of a method of manufacturing the exemplary embodiment of a TFT array panel of FIG. 2;

FIG. 6 is a cross-sectional view taken along line VI-VI of FIG. 5;

FIG. 7 is a cross-sectional view taken along lines VII-VII, and VII′-VII′ of FIG. 5;

FIG. 9 is a cross-sectional view taken along line IX-IX of FIG. 8;

FIG. 10 is a cross-sectional view taken along lines, X-X, and X′-X′ of FIG. 8;

FIG. 12 is a cross-sectional view taken along line XII-XII of FIG. 11;

FIG. 13 is a cross-sectional view taken along lines XIII-XIII, and XIII′-XIII′ of FIG. 11;

FIG. 15 is a cross-sectional view taken along line XV-XV of FIG. 14;

FIG. 16 is a cross-sectional view taken along lines XVI-XVI, and XVI′-XVI′ of FIG. 14;

FIG. 17 is a cross-sectional view taken along line XV-XV of FIG. 14 at a later step in the exemplary embodiment of a method of manufacturing the exemplary embodiment of a liquid crystal panel assembly of the present invention;

FIG. 18 is a cross-sectional view taken along lines XVI-XVI, and XVI′-XVI′ of FIG. 14 at a later step in the exemplary embodiment of a method of manufacturing the exemplary embodiment of a liquid crystal panel assembly of the present invention;

FIG. 20 is a cross-sectional view taken along line XX-XX of FIG. 19;

FIG. 21 is a cross-sectional view taken along lines XXI-XXI, and XXI′-XXI′ of FIG. 19.

FIG. 22 is a top plan view layout illustrating another exemplary embodiment of a TFT array panel according to the present invention;

FIG. 23 is a cross-sectional view taken along line XXIII-XXIII of FIG. 22;

FIG. 24A is a cross-sectional view taken along lines XXIV-XXIV and XXIV′-XXIV′ of FIG. 22; and

FIG. 24B is a magnified view of the area B shown in FIG. 24A.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

An exemplary embodiment of a thin film transistor (“TFT”) array panel according to the present invention is described in detail hereinafter with reference to drawings.

### Exemplary Embodiment 1

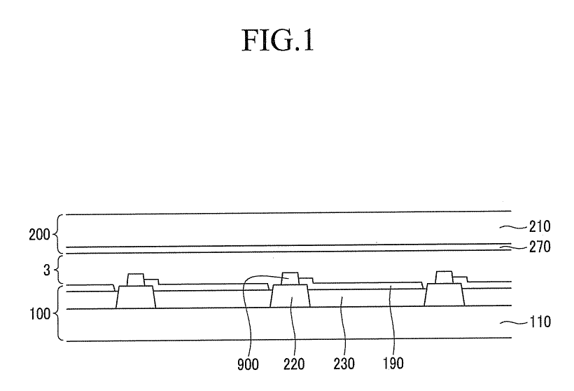

FIG. 1 is a cross-sectional view of an exemplary embodiment of a liquid crystal panel assembly according to the present invention.

Referring to FIG. 1, the exemplary embodiment of a liquid crystal panel assembly includes a TFT array panel 100, a common electrode panel 200, and a liquid crystal layer 3 which is disposed between the two panels 100 and 200.

The TFT array panel 100 includes an insulation substrate 110, a light blocking member 220 which is formed in a substantially matrix shape on the insulation substrate 110, a TFT 900 and wiring (not shown) which are formed on the light blocking member 220, a color filter 230 filled within a storage space which is formed by the light blocking member 220, and a pixel electrode 190 which is connected to the TFT 900 and formed on the color filter 230.

In the present exemplary embodiment the common electrode panel 200 includes an insulation substrate 210 and a common electrode 270 formed on the insulation substrate 210.

In the present exemplary embodiment liquid crystal molecules of the liquid crystal layer 3 are initially aligned to be vertical to surfaces of the two substrates 110 and 210.

In the exemplary embodiment of a TFT array panel 100 according to the present invention, the TFT 900 and the wiring are formed on the light blocking member 220, and the color filter 230 is disposed within a storage space which is formed by the light blocking member 220, which functions similarly to a dam. Therefore, the color filter 230 can be formed with an inkjet method, and there is no need for a contact hole for connecting the TFT 900 and the pixel electrode 190, so that a method of manufacturing the TFT array panel 100 can be simplified and therefore any failures associated with the contact hole collapsing can be reduced.

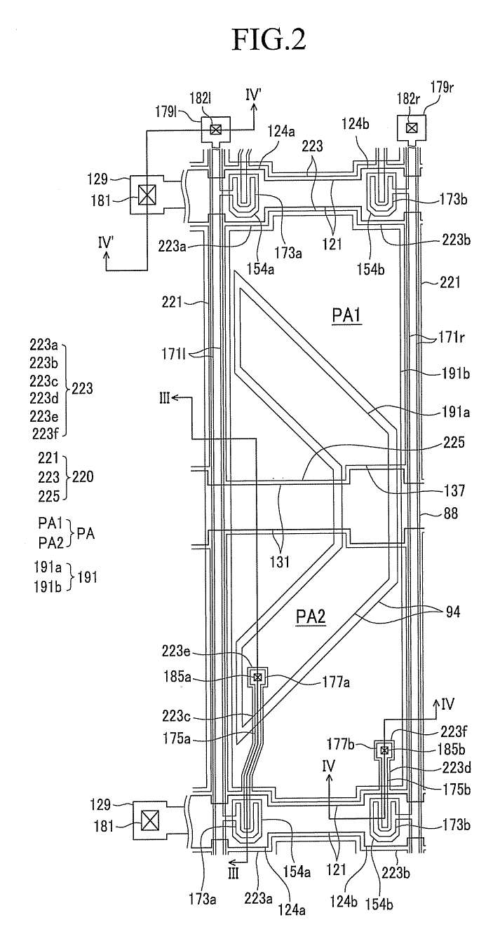

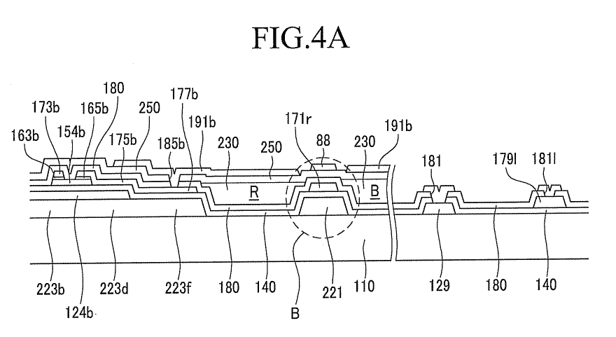

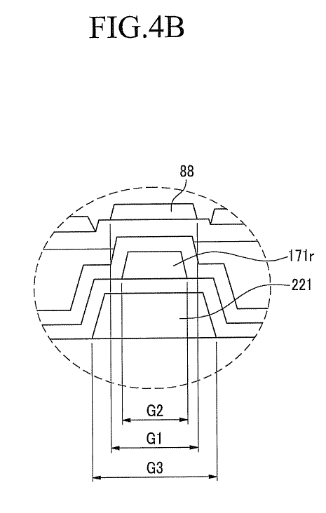

Referring to FIGS. 2 to 4B, an exemplary embodiment of a TFT array panel of an exemplary embodiment of a liquid crystal panel assembly according to the present invention will be described in detail hereinafter.

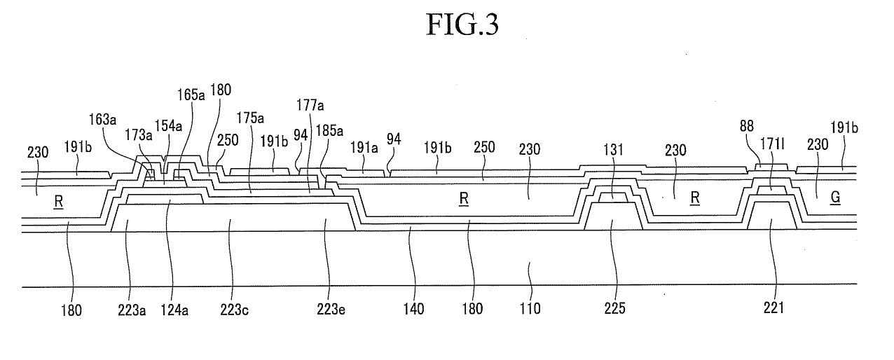

FIG. 2 is a top plan view layout illustrating one pixel of an exemplary embodiment of a TFT array panel, FIG. 3 is a cross-sectional view taken along line III-III of FIG. 2 and FIG. 3 is a cross-sectional view taken along lines IV-IV, and IV′-IV′ of FIG. 2.

The light blocking member 220, which functions to partition a pixel area PA, is formed on the insulation substrate 110. In one exemplary embodiment, the insulation substrate 110 is made of transparent glass or other similar materials. In one pixel area PA, the light blocking member 220 includes a pair of first parts 221 which partition the pixel area PA in a vertical direction and which extend in a substantially vertical direction substantially in parallel to each other. The light blocking member 220 also includes a pair of second parts 223 which partition the pixel area PA in a horizontal direction and which extend in a substantially horizontal direction. Therefore, an isolated storage space approximately corresponding to the pixel area PA is formed by the first parts 221 and the second parts 223. When seen from a top plan view layout, an entire TFT array panel 100 includes a plurality of storage spaces which are partitioned by the light blocking member 220 and arranged substantially in a matrix shape.

The light blocking member 220 also includes a third part 225 which is formed between a pair of the second parts 223. The third part 225 extends in a substantially horizontal direction between a pair of the second parts 223 to bisect the pixel area PA. Accordingly, the pixel area PA is partitioned into an upper region PA1, which is bordered in the vertical direction by the second part of the light blocking member 223 and the third part of the light blocking member 225 and is bordered in the horizontal direction by a pair of first parts of the light blocking member 221, and a lower region PA2, which is bordered in the vertical direction by the third part of the light blocking member 225 and the second part of the light blocking member 223 and is bordered in the horizontal direction by a pair of first parts of the light blocking member 221. Therefore, an isolated storage space corresponding to the pixel area PA is divided into two storage spaces corresponding to each of the upper region PA1 and the lower region PA2.

The second part 223 of the light blocking member 220 includes first and second extensions 223a and 223b, which extend from the first part of the light blocking member 221, and have a relatively large width. The first extension 223a and the second extension 223b extend in a vertical direction to connect to a first branch 223c and a second branch 223d, respectively, which are positioned inside the storage space corresponding to the second pixel area PA2. The first branch 223c and the second branch 223d include end parts 223e and 223f having a substantially wider area than the first and second branch parts 223c and 223d, respectively.

The light blocking member 220 defines an opening region of each pixel, thereby forming a storage space, performs a damning function to be described in more detail below, and also prevents light leakage therethrough.

A gate line 121 is formed on the second part 223 of the light blocking member 220. The gate line 121 extends in a substantially horizontal direction along the second part 223, and transmits a gate signal. The gate line 121 includes a wide end part 129 for connecting to another layer or an external driving circuit and a plurality of protrusions constituting first and second gate electrodes 124a and 124b. In one exemplary embodiment the light blocking member 220 may be formed under the end part 129 of the gate line.

A storage electrode line 131 is formed on the third part 225 of the light blocking member 220. A predetermined voltage such as a common voltage Vcom which is applied to a common electrode is applied to the storage electrode line 131. The storage electrode line 131 extends along the third part 225, and includes a protrusion constituting a storage electrode 137.

In one exemplary embodiment the gate line 121 and the storage electrode line 131 may be made of aluminum metals such as aluminum (Al) and an aluminum alloy, silver metals such as silver (Ag) and a silver alloy, copper metals such as copper (Cu) and a copper alloy, molybdenum metals such as molybdenum (Mo) and a molybdenum alloy, chromium (Cr), titanium (Ti), tantalum (Ta), and various other materials with similar properties. In another exemplary embodiment the gate line 121 and the storage electrode line 131 may have a multi-layered structure including two conductive layers (not shown) each having different physical properties. In such an alternative exemplary embodiment one conductive layer is made of a metal having low resistivity, for example an aluminum metal, a silver metal, or a copper metal, in order to reduce signal delay or voltage drop of the gate line 121 and the storage electrode line 131. In such an alternative exemplary embodiment the other conductive layer is made of a material having excellent contact characteristics with materials such as molybdenum metals, chromium, titanium, or tantalum; exemplary embodiments of such a layer include materials such as indium tin oxide (“ITO”) and indium zinc oxide (“IZO”). One exemplary embodiment includes a chromium lower layer and an aluminum (or aluminum alloy) upper layer, and an aluminum (or aluminum alloy) lower layer and a molybdenum (or molybdenum alloy) upper layer. However, alternative exemplary embodiments include configurations wherein the gate line 121 and the storage electrode line 131 are made of other various metals or conductors.

In one exemplary embodiment side surfaces of the gate line 121 and the storage electrode line 131 are inclined with respect to a surface of the substrate 110. In one such exemplary embodiment an inclination angle thereof is about 30° to about 80°.

A gate insulating layer 140 made of silicon nitride (SiNx) or other similar materials is formed on the gate line 121 and the storage electrode line 131. The gate insulating layer 140 is formed on the light blocking member 220 and the portion of the insulation substrate 110 within the storage space which is formed by the light blocking member 220.

First and second semiconductor islands 154a and 154b, exemplary embodiments of which are made of hydrogenated amorphous silicon (a-Si), polysilicon, or other similar materials, are formed on the gate insulating layer 140. The first and second semiconductor islands 154a and 154b are positioned on the gate line 121, and are positioned on the first extension 223a and the second extension 223b of the second part 223 of the light blocking member 220, respectively.

First ohmic contact islands 163a and 165a and second ohmic contact islands 163b and 165b, exemplary embodiments of which are made of a material such as n+ hydrogenated amorphous silicon in which an n-type impurity such as silicide or phosphorus is doped at a high concentration, are formed on the first semiconductor islands 154a and second semiconductor islands 154b, respectively. The first ohmic contact islands 163a and 165a are formed in a pair to be positioned on the first semiconductor island 154a, and the second ohmic contact islands 163b and 165b are formed in a pair to be positioned on the second semiconductor island 154b.

In one exemplary embodiment sides of the semiconductors 154a and 154b and the ohmic contacts 163a, 165a, 163b, and 165b are inclined with respect to a surface of the substrate 110. In one exemplary embodiment an inclination angle thereof is between about 30° and about 80°.

First and second data lines 171l and 171r and first and second drain electrodes 175a and 175b are formed on the ohmic contacts 163a, 165a, 163b, and 165b and the gate insulating layer 140. In the present exemplary embodiment the first data line 171l is disposed at the left side of the pixel area PA, and the second data line 171r is disposed at the right side of the pixel area PA.

The first and second data lines 171l and 171r are positioned on the first part 221 of the light blocking member 220, and extend in a substantially vertical direction along the first part 221 to intersect the gate line 121 and the storage electrode line 131, and transmit a data voltage. In one exemplary embodiment a light blocking member 220 may be formed under end parts 179l and 179r of the data line.

The first data line 171l includes a first source electrode 173a which is formed on at least a portion of the first gate electrode 124a, and the second data line 171r includes a second source electrode 173b which is formed on at least a portion of the second gate electrode 124b.

In the present exemplary embodiment the first data line 171l and the second data line 171r include end parts 179l and 179r having an extended width, respectively, in order to connect to different layers or an external driving circuit. Because the first source electrode 173a and the second source electrode 173b are formed on the first semiconductor island 154a and the second semiconductor island 154b, respectively, the first source electrode 173a and the second source electrode 173b are also positioned on the first extension 223a and the second extension 223b of the second part 223 of the light blocking member 220, respectively.

The first drain electrode 175a and the second drain electrode 175b are separated from the data lines 171l and 171r and are disposed substantially opposite to the first source electrode 173a and the second source electrode 173b about the first gate electrode 124a and the second gate electrode 124b, respectively. Here, the first drain electrode 175a is positioned on the first branch 223c of the light blocking member 220, and the second drain electrode 175b is positioned on the second branch 223d of the light blocking member 220. In the present exemplary embodiment the first drain electrode 175a and the second drain electrode 175b each include one wide end part 177a and 177b, respectively. In the present exemplary embodiment the ends of the first and second drain electrodes 175a and 175b which are disposed opposite to the wide end parts 177a and 177b are bar type ends. The wide end parts 177a and 177b are positioned on an end part 223f of the first branch 223c and an end part 223e of the second branch 223d, respectively. Bar type end parts of the first drain electrode 175a and the second drain electrode 175b are partly surrounded with the first source electrode 173a and the second source electrode 173b, respectively, which, in the present exemplary embodiment, are curved in a “U” shape.

The first second gate electrode 124a/124b, the first/second source electrode 173a/173b, and the first/second drain electrode 175a/175b together with the first/second semiconductor islands 154a/154b constitute a first/second TFT Qa/Qb, and a channel of the TFT Qa/Qb is formed in the semiconductor 154a/154b between the first/second source electrode 173a/173b and the first/second drain electrode 175a/175b.

In one exemplary embodiment the data lines 171l and 171r and the first and second drain electrodes 175a and 175b are made of a refractory metal such as molybdenum, chromium, tantalum, and titanium, or alloys thereof. In an alternative exemplary embodiment the data lines 171l and 171r and the first and second drain electrodes 175a and 175b may have a multilayer structure including a refractory metal layer (not shown) and a low resistance conductive layer (not shown). One exemplary embodiment of such a multilayered structure includes a dual layer of a chromium or a molybdenum (or an alloy thereof) lower layer, and an aluminum (or an alloy thereof) upper layer. Another exemplary embodiment of a multilayered structure includes a triple layer of a molybdenum (or an alloy thereof) lower layer, an aluminum (or an alloy thereof) middle layer, and a molybdenum (or an alloy thereof) upper layer. However, alternative exemplary embodiments include configurations wherein the data lines 171l and 171r and the first and second drain electrodes 175a and 175b may be made of various other metals or conductors.

In one exemplary embodiment sides of the data lines 171l and 171r and the drain electrodes 175a and 175b are inclined with respect to the insulating substrate 110 by an angle of about 30° to about 80°.

In the present exemplary embodiment the ohmic contacts 163a, 165a, 163b, and 165b are disposed only between the lower semiconductors 154a and 154b and the source electrodes 173 and 173b and drain electrodes 175a and 175b. The ohmic contacts 163a, 163b, 165a and 165b perform a function of lowering contact resistance.

A passivation layer 180 is formed on the data lines 171l and 171r, the source electrodes 173a and 173b, the drain electrodes 175a and 175b, the exposed semiconductors 154a and 154b, and the pixel area PA. In one exemplary embodiment the passivation layer 180 is made of silicon nitride or silicon oxide, or other similar materials. In one exemplary embodiment the passivation layer 180 is formed on the gate insulating layer 140 within the storage space which is formed by the light blocking member 220.

A color filter 230 is formed on the passivation layer 180 within the storage space which is formed by the light blocking member 220.

As described above, the light blocking member 220 partitions one pixel area PA into two isolated storage spaces by a combination of the first part 221, the second part 223, and the third part 225, and all of the gate line 121, the data lines 171l and 171r, the storage electrode line 131, and the first and second TFTs Qa and Qb are all formed on the light blocking member 220. Therefore, a color filter 230 can be formed by injecting a color filter material into each storage space with an inkjet process. In one exemplary embodiment the color filter material may be a liquid. Furthermore, the color filter 230 is formed to be substantially flat and substantially fills the storage space to approximately the height of the TFTs Qa and Qb. Therefore, it becomes unnecessary to add an additional flattening layer and a method for manufacturing the exemplary embodiment of a TFT array panel may be correspondingly shortened. Because the color filter 230 is formed after the TFTs Qa and Qb are entirely formed, only the heat resistance of the light blocking member 220 needs to be considered when forming the TFT, so that an upper limit value of a process temperature can be increased as compared to when the temperature resistance of a color filter layer must also be considered.

In one exemplary embodiment the color filter 230 in each pixel area PA may be formed with one of red, green, and blue colors. In such an exemplary embodiment, the same color filter 230 is formed in the upper region PA1 and the lower region PA2, e.g., if a red color filter R is formed in the upper region PA1, the red color filter R is also formed in the lower region PA2. In one exemplary embodiment the same color filter 230 is formed in neighboring pixel areas PA in a vertical direction, and differently colored color filters 230 are disposed to be adjacent in neighboring pixel areas PA in a horizontal direction.

An overcoat 250 is formed on the color filter 230. In one exemplary embodiment the overcoat 250 is made of an inorganic or organic insulating material. The overcoat 250 prevents the color filter 230 from being exposed to contaminants or mechanical deformation and provides a flat surface on which to place additional components. In alternative exemplary embodiments the overcoat 250 may be omitted.

Contact holes 1821, 182r, 185a, and 185b for exposing end parts 179l and 179r of the data lines 171l and 171r and the end parts 177a and 177b of the first and second drain electrodes 175a and 175b are formed in the overcoat 250 and the passivation layer 180. A contact hole 181 for exposing the end part 129 of the gate line 121 is formed in the overcoat 250, the passivation layer 180, and the gate insulating layer 140.

First and second subpixel electrodes 191a and 191b and a shielding electrode 88 are formed on the overcoat 250. In one exemplary embodiment the first and second subpixel electrodes 191a and 191b and the shielding electrode 88 are made of a transparent conductive material, exemplary embodiments of which include ITO and IZO, or of a reflective metal, exemplary embodiments of which include aluminum, silver, or alloys thereof.

The first subpixel electrode 191a and the second subpixel electrode 191b are physically and electrically connected to the first drain electrode 175a and the second drain electrode 175b through contact holes 185a and 185b, respectively. The first and second subpixel electrodes 191a and 191b receive a data voltage from the first drain electrode 175a and the second drain electrode 175b, respectively.

The two subpixel electrodes 191a and 191b to which the data voltage is applied together with the common electrode 270 generate an electric field, thereby determining arrangement of liquid crystal molecules in the liquid crystal layer 3 disposed therebetween.

In the current exemplary embodiment, the first subpixel electrode 191a receives a data voltage from the first data line 171l and the second subpixel electrode 191b receives a data voltage from the second data line 171r, whereby the two subpixel electrodes 191a and 191b receive different voltages. When different voltages are applied to the different subpixel electrodes 191a and 191b the electric field strength between the different subpixel electrodes 191a and 191b and the common electrode 270 also becomes different, and therefore an arrangement state of the liquid crystals in the corresponding areas also becomes different. If the arrangement state of the liquid crystal is properly adjusted, an image that is seen from the side can be similar to an image which is seen from the front. This effectively increases the aperture ratio of a particular pixel area PA. That is, side visibility of a liquid crystal display can be improved.

A cutout (not shown) may be formed in the two subpixel electrodes 191a and 191b and the common electrode 270, or a protrusion (not shown) may be formed on the two subpixel electrodes 191a and 191b and the common electrode 270, or a combination of protrusions and apertures may be formed on the two subpixel electrodes 191a and 191b and the common electrode 270. The cutout or the protrusion causes generation of a horizontal component of an electric field to control an alignment operation of liquid crystal. Thus, the cutouts (not shown) or protrusions (not shown) may also increase an aperture ratio of the display.

Further, the subpixel electrodes 191a and 191b and the common electrode 270 constitute liquid crystal capacitors Clca and Clcb, and therefore the subpixel electrodes 191a and 191b and the common electrode 270 sustain an applied voltage even after the TFTs Qa and Qb are turned off. Voltage sustainability is also increased by storage capacitors Csta and Cstb, which are connected in parallel thereto are formed by overlapping the first and second subpixel electrodes 191a and 191b with the storage electrode line 131.

In the current exemplary embodiment a pair of the first and second subpixel electrodes 191a and 191b constituting one pixel electrode 191 are disposed substantially opposite to each other with a gap 94 interposed therebetween. Alternative exemplary embodiments of the pixel electrode 191 can have various forms.

Referring now to FIGS. 1-4B, the shielding electrode 88 is formed on the data lines 171l and 171r to receive the same voltage as that of the common electrode 270. The shielding electrode 88 prevents a voltage of the data lines 171l and 171r from influencing the liquid crystal layer 3 along their length and is formed wider than a width G2 of the data line 171. A width G3 of the first part 221 of the light blocking member 220 is formed wider than a width G1 of the shielding electrode 88 to prevent light leakage occurring. Resultantly, the shielding electrode 88 is wider than the data line 171 and is narrower than the first part 221. Alternative exemplary embodiments include configurations wherein the shielding electrode 88 has various sizes. Alternative exemplary embodiments also include configurations wherein the shielding electrode 88 may be omitted.

Although the above described exemplary embodiments include configurations having multiple pixel areas PA, multiple transistors Q1 and Q2, multiple data wirings 124a, 124b, 171l, 171R, 173a, 173b, and various other duplicate components, alternative exemplary embodiments include configurations wherein each pixel of the TFT array includes singular members of the components described above.

An exemplary embodiment of a method of manufacturing the exemplary embodiment of a TFT array panel having the above-described configuration will be described hereinafter.

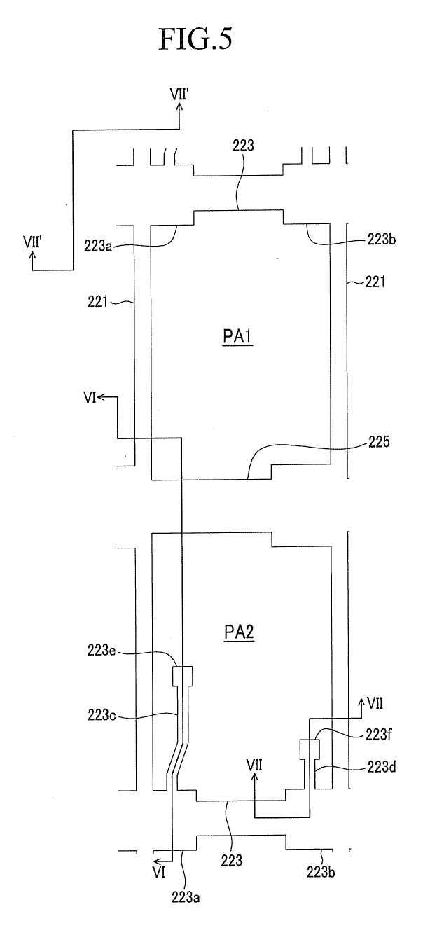

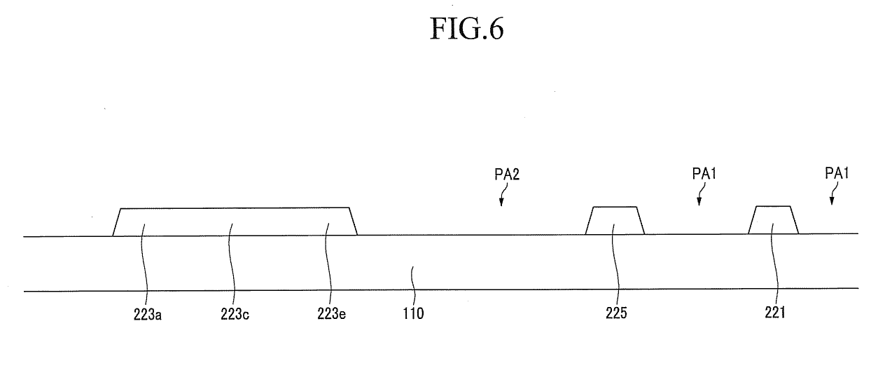

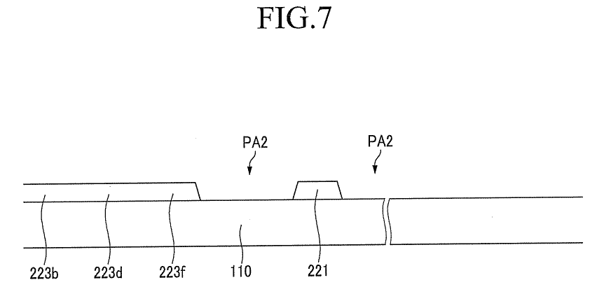

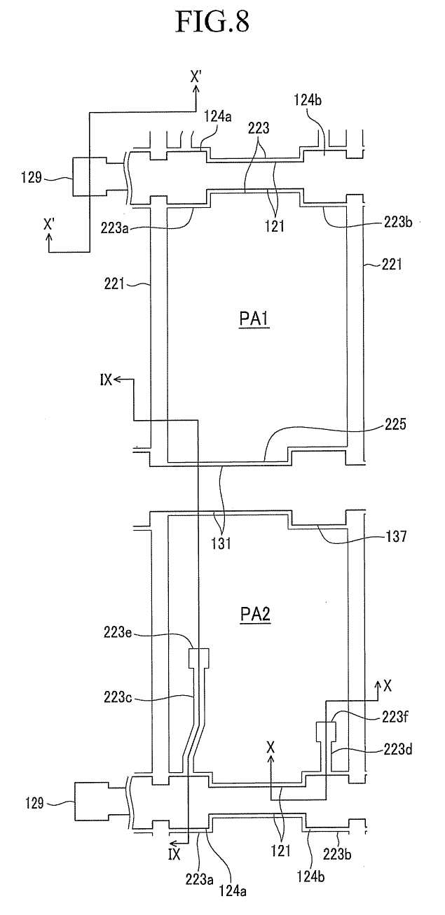

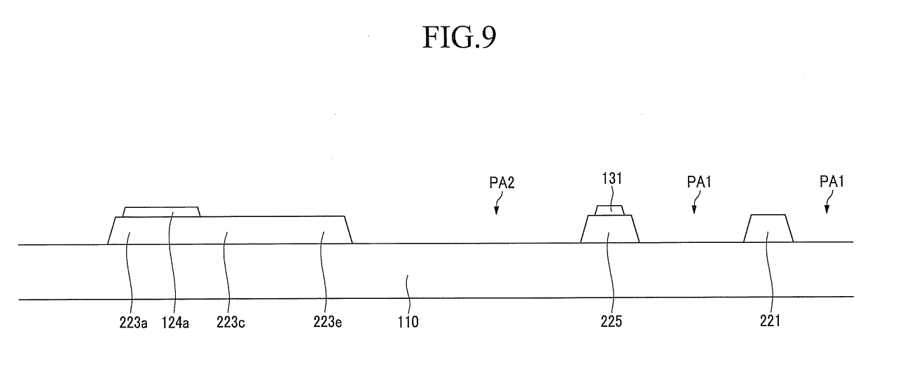

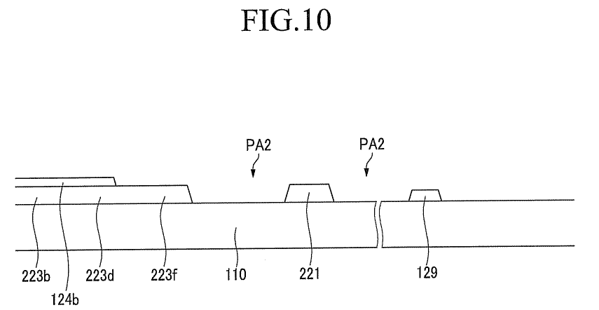

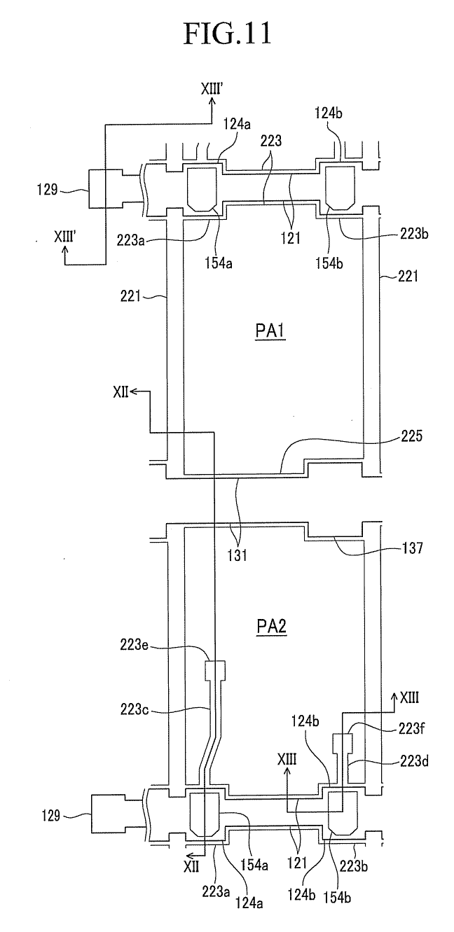

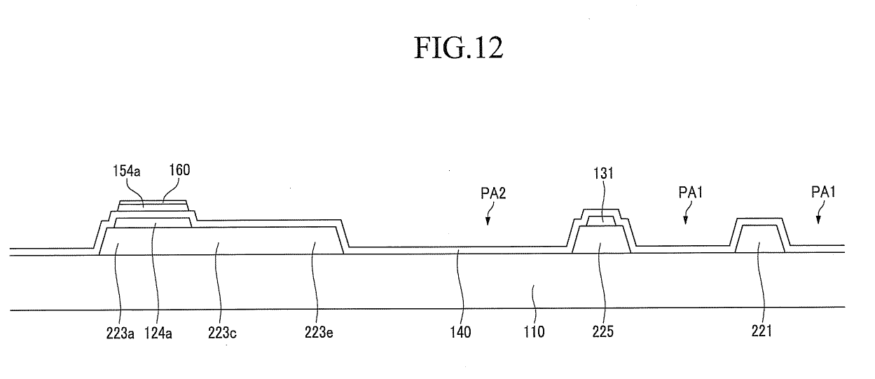

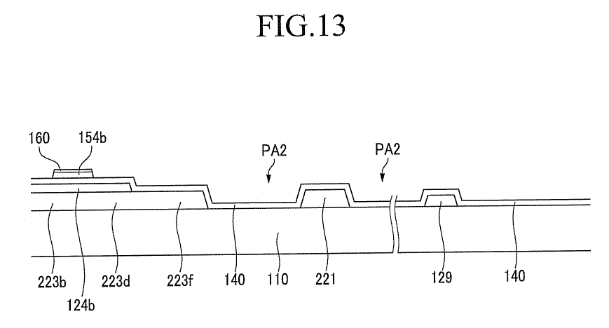

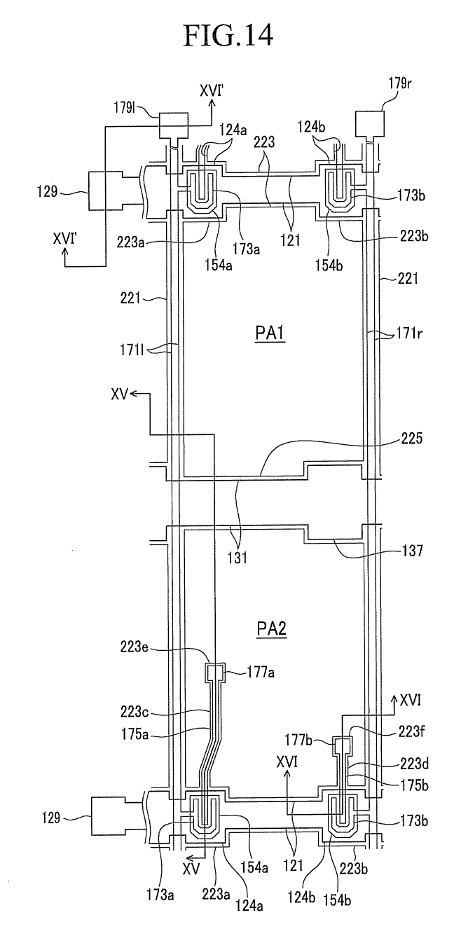

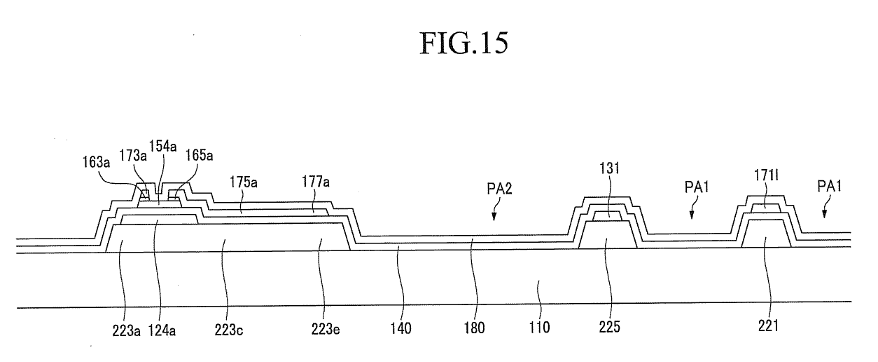

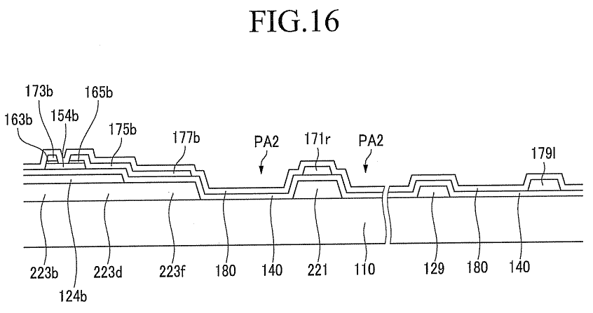

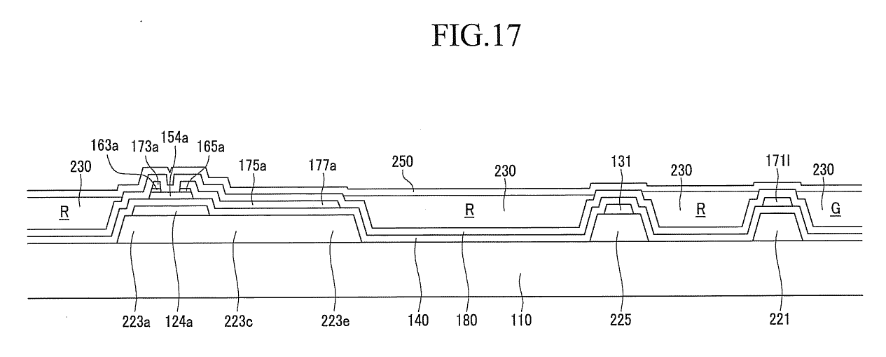

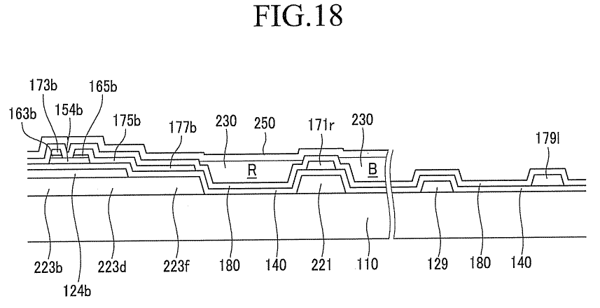

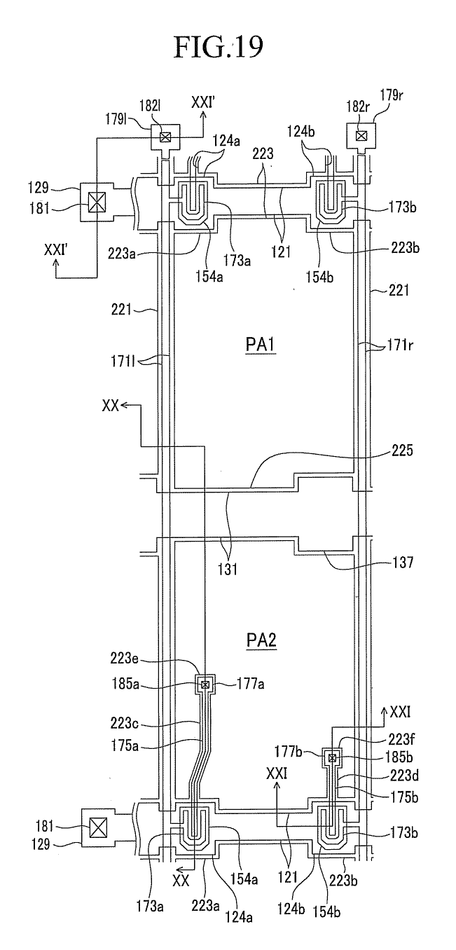

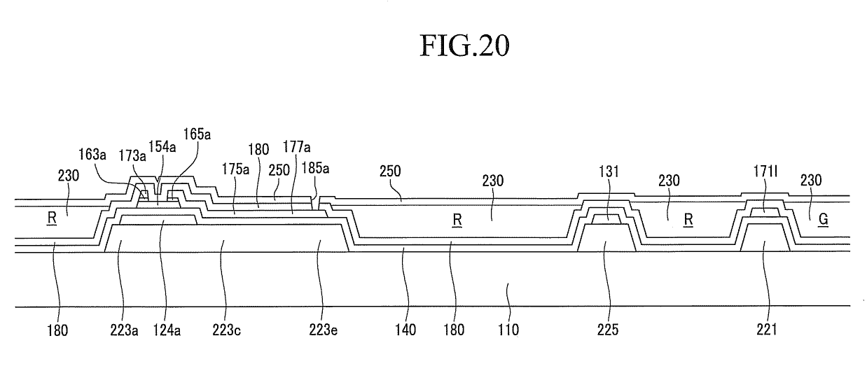

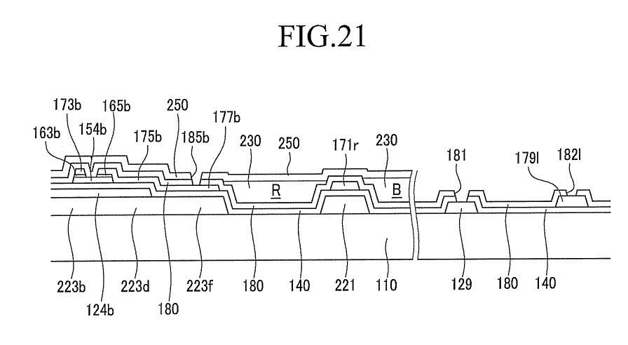

FIGS. 5 to 7 illustrate an exemplary embodiment of a process of forming a light blocking member 220, FIGS. 8 to 10 illustrate a process of forming a gate line 121, FIGS. 11 to 13 illustrate a process of forming a pair semiconductors 154a and 154b, FIGS. 14 to 16 illustrate a process of forming a pair of data lines 171l and 171r and a pair of drain electrodes 175a and 175b, FIGS. 17 and 18 illustrate a process of forming a color filter 230, and FIGS. 19 to 21 illustrate a process of forming a plurality of contact holes 181, 1821, 182r, 185a and 185b.

First, as shown in FIGS. 5 to 7, by coating, exposing, and developing a photoresist in which black pigment is dispersed on the insulation substrate 110, exemplary embodiments of which are made of transparent glass or plastic, a light blocking member 220 including the first part 221, the second part 223, and the third part 225 is formed. The light blocking member 220 partitions the pixel area. In the present exemplary embodiment, the light blocking member 220 is formed at a predetermined height, and is made of an organic material having excellent heat resistance. In alternative exemplary embodiments wherein the light blocking member 220 is made of an organic material having no photosensitivity, the light blocking member 220 may be patterned with a photolithographic method.

Thereafter, as shown in FIGS. 8 to 10, by depositing and performing photolithography on a metal film, exemplary embodiments of which include an aluminum-neodymium (“AlNd”) film and a molybdenum (Mo) film, disposed on the light blocking member 220 and the insulation substrate 110, a gate line 121 including the gate electrodes 124a and 124b and the end part 129 and a storage electrode line 131 including the storage electrode 137 are formed on the second part 223 and the third part 225 of the light blocking member 220, respectively. Accordingly, the gate line 121 and the storage electrode line 131 are formed to be disposed along in a substantially horizontal direction on the second part 223 and the third part 225 of the light blocking member 220.

Thereafter, as shown in FIGS. 11 to 13, the gate insulating layer 140, exemplary embodiments of which are made of silicon nitride (SiNx) or other similar materials, is formed on the gate line 121 and the storage electrode line 131. Semiconductors 154a and 154b and a preliminary ohmic contact 160 are formed in an island shape by stacking and performing photolithography on amorphous silicon (a-Si) layers wherein impurities are not, and are heavily doped, respectively. Accordingly, the semiconductors 154a and 154b are formed on the gate electrodes 124a and 124b, which in turn are deposited on the second part 223 of the light blocking member 220.

Next, as shown in FIGS. 14 to 16, the data lines 171l and 171r and the drain electrodes 175a and 175b including the first and second source electrodes 173a and 173b and the end parts 179l and 179r, respectively, are formed by depositing and performing photolithography to form a metal layer on the preliminary ohmic contact 160. In one exemplary embodiment the metal layer is molybdenum or aluminum. In such an exemplary embodiment, the data lines 171l and 171r are formed on the first part 221 of the light blocking member 220, and the first source electrode 173a and the second source electrode 173b are formed on the semiconductors 154a and 154b, respectively, with the preliminary ohmic contact layers 160 disposed therebetween. Therefore, the first source electrode 173a and the second source electrode 173b are formed on the second part 223 of the light blocking member 220. Furthermore, the drain electrodes 175a and 175b are formed on the branches 223c and 223d, respectively, which are formed extending from the second part 223 of the light blocking member 220.

Thereafter, by removing a portion of the amorphous silicon layer which is exposed by the source electrodes 173a and 173b and the drain electrodes 175a and 175b, ohmic contacts 163a, 165a, 163b, and 165b are completed, and the lower semiconductors 154a and 154b are exposed.

Next, a passivation layer 180, exemplary embodiments of which are made of an insulating material such as silicon nitride (“SiNx”), is disposed on the gate insulating layer 140, the source and drain electrodes 173a, 173b, 175a and 175b and the exposed portion of the semiconductors 154a and 154b.

Thereafter, as shown in FIGS. 17 and 18, a color filter 230 is formed by injecting ink into a storage space which is formed in each of the first and second pixel areas PA1 and PA2 which are divided by the first part 221, the second part 223, and the third part 225 of the light blocking member 220. In one exemplary embodiment ink which is filled within the storage space with an inkjet method is hardened by heat and has a substantially flat surface. Thereafter, an overcoat 250 is formed on the color filter 230.

Next, as shown in FIG. 19, by patterning the overcoat 250, the passivation layer 180, and the gate insulating layer 140 together, contact holes 181, 1821, 182r, 185a, and 185b are formed. The contact holes 181, 1821, 182r, 185a, and 185b partially expose end parts 129, 1791, and 179r of the gate line 121 and the data lines 171l and 171r, and the drain electrodes 175a and 175b.

Thereafter, as shown in FIGS. 1 to 3, by depositing a transparent conductive material, exemplary embodiments of which include IZO and ITO, and performing photolithography, first and second subpixel electrodes 191a and 191b and a shielding electrode 88 are formed.

### Exemplary Embodiment 2

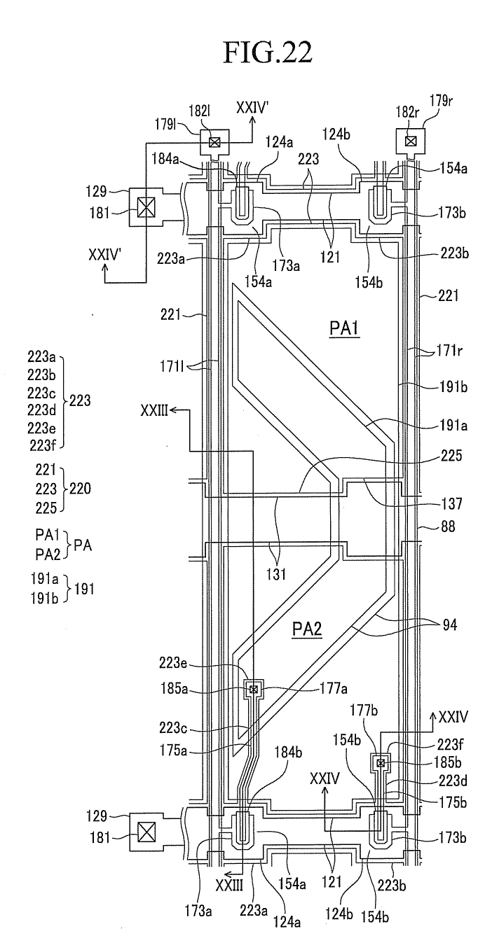

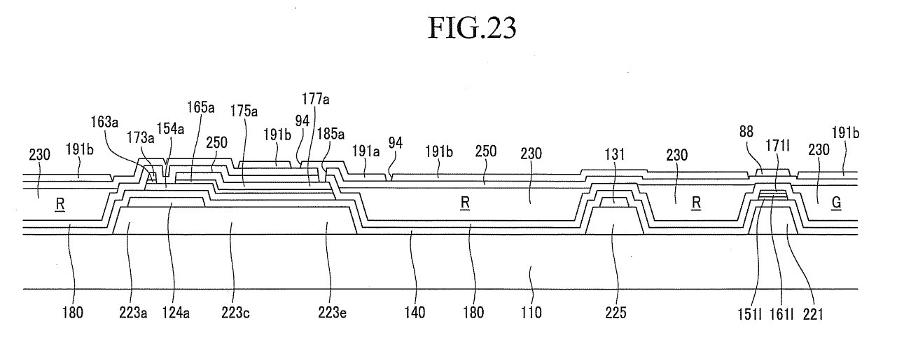

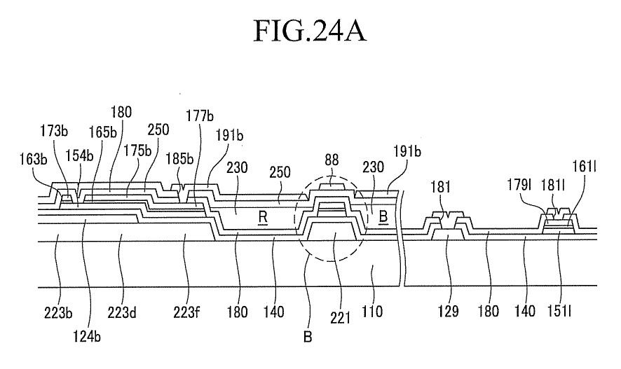

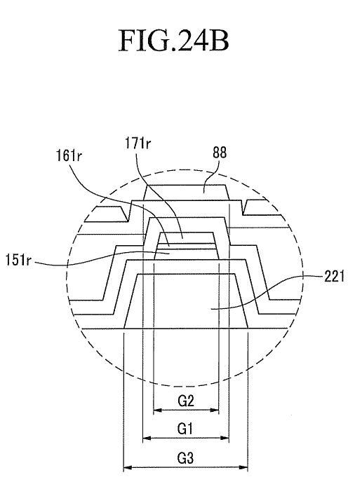

FIG. 22 is a top plan view layout of another exemplary embodiment of a TFT array panel according to the present invention, FIG. 23 is a cross-sectional view taken along line XXIII-XXIII of FIG. 22, FIG. 24A is a cross-sectional view taken along lines XXIV-XXIV and XXIV′-XXIV′ of FIG. 22, and FIG. 24B is an enlarged view of the area B shown in FIG. 24A.

A structure of another exemplary embodiment of a TFT array panel according to the present invention is substantially similar to that of FIGS. 2 to 4, and therefore a repeated detailed description thereof is omitted and only parts which are different are described.

The exemplary embodiment of FIGS. 22 to 24B is different from the exemplary embodiment of FIGS. 2 to 4 in that ohmic contacts 1611, 161r, 163a, 165a, 163b, and 165b and semiconductors 1511, 151r, 154a, and 154b are disposed under substantially the entire length of the data lines 171l and 171r and the drain electrodes 175a and 175b. The ohmic contacts 1611, 161r, 163a, 165a, 163b, and 165b have a pattern substantially identical to the upper data lines 171l and 171r and drain electrodes 175a and 175b, and the semiconductors 1511, 151r, 154a, and 154b further include a portion for forming a channel between the source electrodes 173a and 173b and the drain electrodes 175a and 175b.

In the present exemplary embodiment such a structure is formed because the semiconductors 1511, 151r, 154a, and 154b, the ohmic contacts 1611, 161r, 163a, 165a, 163b, and 165b, the data lines 171l and 171r, and the drain electrodes 175a and 175b are formed with one photolithography process using one photosensitive film pattern having different thicknesses. In such an exemplary embodiment a photosensitive film pattern having different thicknesses is formed using a half-tone exposure mask having a slit pattern or a translucent film, or using a reflow process. However, alternative exemplary embodiments include configurations wherein the photosensitive film having different thicknesses is formed by different processes.

An exemplary embodiment of a method of manufacturing the exemplary embodiment of a TFT array panel as shown in FIGS. 22 to 24 according to the present invention will now be described. The current exemplary embodiment is substantially similar to the process shown in FIGS. 5 to 21, and therefore only the differences between the two are briefly described.

First, a light blocking member 220 for forming a storage space on the insulation substrate 110 is formed.

Next, a gate line 121 and a storage electrode line 131 are formed on the light blocking member 220.

Next, a gate insulating layer 140, a semiconductor layer, an ohmic contact layer, a metal layer for transmitting data signals, and a photosensitive film are sequentially stacked on the gate line 121 and the storage electrode line 131, and a photolithography process is performed on the photosensitive film using a half-tone mask, whereby a photosensitive film pattern having different thicknesses according to position is formed. In the current exemplary embodiment, the photosensitive film pattern is thick in a portion corresponding to a portion in which the data lines 171l and 171r and the drain electrodes 175a and 175b are to be formed, and is thin in a corresponding portion between the source electrodes 173a and 173b and the drain electrodes 175a and 175b. By etching the metal layer for transmitting data signals, the ohmic contact layer, and the semiconductor layer using the photosensitive film pattern as a mask, a preliminary data line, a preliminary ohmic contact, and semiconductors 1511, 151r, 154a, and 154b are formed, and by ashing the photosensitive film pattern, a corresponding thin portion between the source electrodes 173a and 173b and the drain electrodes 175a and 175b is removed. By etching the exposed preliminary data line and the preliminary ohmic contact using the ashed photosensitive film pattern as a mask, the data lines 171l and 171r, the drain electrodes 175a and 175b, and the lower ohmic contacts 1611, 161r, 163a, 165a, 163b, and 165b are completed. In the current exemplary embodiment, the semiconductors 1511, 151r, 154a, and 154b, the ohmic contacts 1611, 161r, 163a, 165a, 163b, and 165b, the data lines 171l and 171r, and the drain electrodes 175a and 175b are positioned on the light blocking member 220.

Next, a passivation layer 180 is formed on the data lines 171l and 171r and the drain electrodes 175a and 175b.

Then, a color filter 230 is formed in a storage space defined by the light blocking members 220, and an overcoat 250 is formed on the color filter 230 with an inkjet method.

Thereafter, by patterning the overcoat 250, the passivation layer 180, and the gate insulating layer 140 together, contact holes 181, 1821, 182r, 185a, and 185b are formed.

Next, first and second subpixel electrodes 191a and 191b and a shielding electrode 88 are formed on the overcoat 250.

The exemplary embodiment of a TFT array panel shown in FIGS. 22 to 24 according to present invention uses at least one less photolithography process than that of the exemplary embodiment shown in FIGS. 2 to 4.

According to the present invention, because a light blocking member 220 independently forms a storage space in which a color filter 230 is to be filled in each pixel area, the color filter 230 can be formed with an inkjet method, whereby the manufacturing process of the resulting display may be simplified.

Furthermore, in terms of process order, because a color filter 230 is formed after a TFT is formed, the temperature conditions for forming a TFT are less restricted.

Further, because a contact hole for connecting a pixel electrode and a TFT is formed on a light blocking member in which a color filter does not exist, a failure in which a contact hole collapses due to deformation of the color filter layer can be eliminated.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A thin film transistor array panel comprising:
a substrate;
a light blocking member disposed on the substrate, wherein the light blocking member forms a storage space;
a gate line which extends in a first direction on the substrate and includes a gate electrode;
a gate insulating layer disposed on the gate line;
a semiconductor disposed on the gate insulating layer;
a data line disposed on the gate insulating layer, which extends in a second direction, which is disposed at an angle to the first direction, and includes a source electrode, wherein at least a part of the source electrode is positioned on the semiconductor;
a drain electrode disposed substantially opposite the source electrode on the semiconductor;
a passivation layer disposed on the data line and the drain electrode and which includes a contact hole which exposes the drain electrode;
a color filter disposed within the storage space; and
a pixel electrode disposed on the passivation layer and which is connected to the drain electrode through the contact hole.

2. The thin film transistor array panel of claim 1, wherein the pixel electrode is disposed on the color filter.

3. The thin film transistor array panel of claim 1, further comprising a storage electrode line disposed in the first direction on the light blocking member.

4. The thin film transistor array panel of claim 1, wherein the gate line and the data line are positioned on the light blocking member.

5. The thin film transistor array panel of claim 1, further comprising an ohmic contact disposed between the semiconductor and the data line, and between the semiconductor and the drain electrode.

6. The thin film transistor array panel of claim 5, wherein the ohmic contact is disposed in substantially the same pattern as that of the data line and the drain electrode.

7. The thin film transistor array panel of claim 1, further comprising a shielding electrode disposed on the passivation layer and extending in the second direction substantially along the data line.

8. The thin film transistor array panel of claim 1, further comprising an overcoat disposed between the color filter and the pixel electrode.

9. The thin film transistor array panel of claim 1, wherein the color filter is disposed on the passivation layer within the storage space.

10. The thin film transistor array panel of claim 1, wherein:
the data line comprises a first data line disposed at the left side of the storage space and a second data line disposed at the right side of the storage space; and
the pixel electrode comprises a first subpixel electrode which receives a data voltage from the first data line and a second subpixel electrode which receives a data voltage from the second data line.

11. The thin film transistor array panel of claim 10, wherein the first data line, the second data line, the drain electrode, and the source electrode are positioned on the light blocking member.

12. A film transistor array panel comprising:
a substrate;
a light blocking member disposed on the substrate;
a gate line positioned on the light blocking member and which extends in a first direction;
a data line positioned on the light blocking member and which extends in a second direction which is disposed at an angle to the first direction;
a thin film transistor positioned on the light blocking member and which is connected to the gate line and the data line; and
a pixel electrode connected to the thin film transistor.

13. The thin film transistor array panel of claim 12, wherein the light blocking member forms a storage space; and
a color filter is disposed within the storage space.

14. A method of manufacturing a thin film transistor array panel, comprising:
disposing a light blocking member, which forms a plurality of isolated storage spaces, on a substrate;
disposing a gate line extending in a first direction on the substrate;
disposing a gate insulating layer on the gate line;
disposing a semiconductor on the gate insulator layer;
disposing a data line extending in a second direction, which is disposed at an angle to the first direction, on the substrate;
disposing a drain electrode extending in the second direction on the substrate;
disposing a passivation layer on the data line and the drain electrode;
disposing a color filter within the storage spaces; and
disposing a pixel electrode in connection with the drain electrode.

15. The method of claim 14, wherein the forming of the color filter comprises:
injecting ink within the storage spaces; and
hardening the ink.

16. The method of claim 14, wherein the gate line and the data line are positioned on the light blocking member.

17. The method of claim 16, wherein the forming of the gate line further comprises positioning a storage electrode line extending in the first direction on the light blocking member.

18. The method of claim 14, further comprising forming an ohmic contact layer after disposing the semiconductor and before disposing the data line.

19. The method of claim 18, wherein the disposing a semiconductor, the disposing an ohmic contact layer and the disposing a data line and a drain electrode comprises:
sequentially disposing a semiconductor layer, an ohmic contact layer and a metal layer on the gate insulating layer;
disposing a first photosensitive film pattern having a position-varying thickness on the metal layer;
etching the metal layer, the ohmic contact layer and the semiconductor layer using the first photosensitive film pattern as a mask;
forming a second photosensitive film pattern which exposes at least a portion of the metal layer by ashing the first photosensitive film pattern; and
etching the exposed metal layer and the ohmic contact layer using the second photosensitive film pattern as a mask.

20. The method of claim 14, further comprising disposing an overcoat on the color filter between the disposing of the color filter and the disposing of the pixel electrode.

21. The method of claim 14, wherein the forming of a pixel electrode further comprises forming a shielding electrode extending in the second direction substantially along the data line.
